(19) United States
(12) Patent Application Publication
(10) Pub. No.: US 2008/0258571 A1
(43) Pub. Date: Oct. 23, 2008

(54) Electric Drive Unit, in Particular Electric Motor with Gear

(76) Inventor: Achim Hawighorst, Buehlertal (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/093,983

(22) PCT Filed: Sep. 26, 2006
(86) PCT No.: PCT/EP2006/066730

§ 371 Date: May 16, 2008

(30) Foreign Application Priority Data
Nov. 25, 2005 (DE) 10 2005 056 201.9

(51) Int. Cl. H02K 7/08; H02K 7/116

(52) U.S. Cl. 310/83

(57) ABSTRACT

The invention relates to all electric drive unit (10), in particular an electric motor (11) with a transmission (12), whose driveshaft (15) is rotatably mounted at the transmission side in a ball bearing (16) on the transmission housing (14), which ball bearing (16) is axially fixed at one side against a stop shoulder (18a) of the bearing bore (18) and at the other side by means of at least one locking part in the bearing bore. For a cost-effective bearing fixing arrangement which is simple to assemble, it is proposed that the ball bearing (16) is axially fixed by means of at least one locating pin (22), which is fastened in the transmission housing (14) and extends chordwise through the bearing bore (18), as a locking part, wherein an elastic element (21) for tolerance compensation is arranged at least on one end side of the ball bearing (16).

### PRIOR ART

The invention relates to an electric drive unit, in particular to an electric motor with a gear, for motor vehicle windshield wiper systems, as generically defined by the preamble to claim 1.

In an electric drive unit for the wiper system of a motor vehicle, known from German Patent DE 198 39 407 C1, the driveshaft of the electric motor is received on the gear end in a ball bearing that is inserted into a bearing bore of the gearbox. The ball bearing is axially fixed in the bearing bore of the gearbox by a locking part. For axial compensation for tolerances of the bearing in the gearbox, the locking part is additionally provided there with spring tongues, which are braced elastically on the outer ring of the ball bearing. The back side of the ball bearing rests on a stop shoulder of the gearbox. However, such embodiments are relatively expensive, since the locking part, in the form of a U-shaped clamp, has to be manufactured especially for each bearing size. Moreover, the clamp must be made from high-quality spring steel, so that the elastic spring tongues that are required for tolerance compensation can be made out of the clamp. Another expense arises because a suitably dimensioned recess for inserting this locking clamp has to be made in the gearbox.

With the present embodiment, the object, in an electric drive unit of the type defined at the outset, is to attain a sufficiently solid seat of the bearing in the gearbox by using economical standard parts and by simple mounting of these standard parts.

Such drive units having the definitive characteristics of claim 1 have the advantage that by the use and chordlike disposition of at least one bolt, especially a standardized alignment pin, axial fixation of the bearing is achieved in the simplest and most economical possible way. It is considered to be a further advantage that the axial fixation of the bearing and the axial tolerance compensation no longer need to be accomplished with one and the same component; instead, a further standard component can be used as an elastic element for compensating for the tolerance of the bearing.

By means of the provisions recited in the dependent claims, expedient embodiments and refinements of the characteristics recited in claim 1 are attained.

For securely fixing the ball bearing axially in the gearbox even against such major mechanical forces as impact stresses, the bearing bore is advantageously penetrated in chordlike fashion by two alignment pins diametrically opposite one another and spaced apart. Optimal axial locking of the ball bearing can be attained advantageously by providing that the spacing of the two alignment pins from one another is greater than the outer diameter of an inner ring of the ball bearing, the inner ring being secured to the driveshaft of the electric motor. For reliable axial fixation of the ball bearing, it is moreover expedient if the spacing of the two alignment pins from one another is not greater than the inside diameter of an outer ring of the bearing, the outer ring being secured in the bearing bore. Finally, for the mounting of the alignment pins, it is simplest from a manufacturing standpoint if the alignment pins are inserted into bores in the gearbox that penetrate the bearing bore in chordlike fashion. These bores are preferably embodied as blind bores, to avoid unnecessary holes in the outer wall of the gearbox.

In the simplest way, for axial tolerance compensation between the ball bearing and the bearing bore, a cup spring in the form of a standard part is fastened between the bearing and the stop shoulder of the gearbox. To compensate for major axial tolerances, however, it is equally possible for a further cup spring to be fastened as a standard part between the alignment pins on the one hand and the bearing on the other.

### DRAWINGS

The invention will be described in further detail below in terms of examples in conjunction with the drawings. Shown are:

FIG. 1, a structural unit comprising an electric motor and a gear for a windshield wiper system in motor vehicles;

FIG. 2, the bearing point of the driveshaft of the electric motor in the gearbox, in a fragmentary longitudinal section;

FIG. 3 shows the same fragmentary view in cross section; and

FIG. 4 shows a bearing point modified somewhat compared to FIG. 2.

### DESCRIPTION OF THE EXEMPLARY EMBODIMENTS

In FIG. 1, an electric drive unit, marked 10, according to the invention is shown, which comprises an electric motor 11 and a gear 12 and is used to drive wipers on the windshield of motor vehicles. The electric motor 11 is secured on the face end to a gear flange 13 of the gearbox 14; the driveshaf 15 of the electric motor is rotatably supported on the gear in a ball bearing 16 in the gearbox 14 and is embodied on its end protruding from the gearbox as a drive worm 17. The ball bearing 16 is inserted into a bearing bore 18 in a bracket 19 of the gearbox 14.

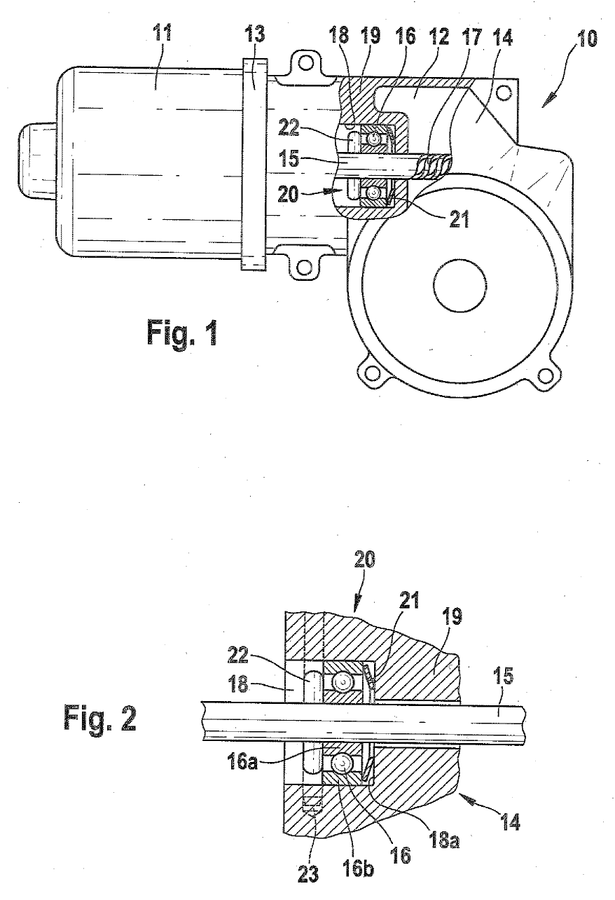

FIG. 2, in a fragmentary view of the gearbox, shows the bearing point 20 of the driveshaft 15 in longitudinal section. Here, the ball bearing 16 is secured by its inner ring 16a on the driveshaft 15 of the electric motor, and with its outer ring 16b, it is press-fitted into the bearing bore 18 of the gearbox 14. Behind the ball bearing 16, the bearing bore 18 has a stop shoulder 18a, which is embodied on the bracket 19 of the gearbox 14 and on which an elastic cup spring 21, available on the market as an economical, conventional standard part, is braced. The ball bearing 16 is axially fixed on the motor end of the bearing bore 18 by means of alignment pins 22, which are each press-fitted into a blind bore 23 in the gearbox 14, and against which the ball bearing 16 is axially braced by means of the prestressed cup spring 21.

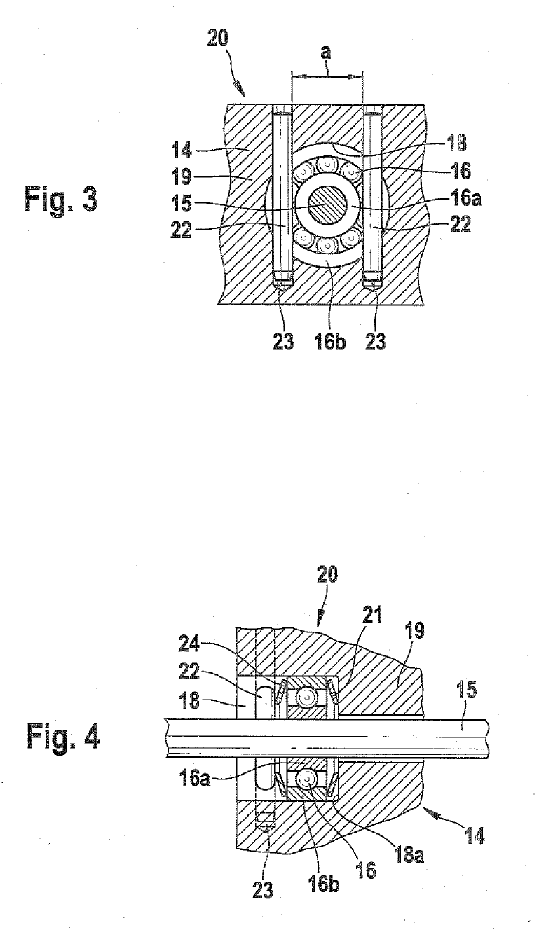

FIG. 3 shows the same bearing point 20 of the driveshaft 15 in the gearbox 14, in cross section. Here it can be seen that the bearing bore 18 is penetrated in chordlike fashion by two alignment pins 22 diametrically opposite one another at a spacing a. To avoid noise from friction of the ball bearing inner ring 16a at the alignment pins 22, the spacing a of the two alignment pins 22 from one another is selected to be greater than the outer diameter of the inner ring 16a of the bearing. It can also be seen here that the blind bores 23 of the gearbox 14, for insertion of the alignment pins 22, likewise completely penetrate the bearing bore 18 in chordlike fashion. Upon mounting of the ball bearing 16, consequently for compensating for tolerances in the axial fixation of the ball bearing 16, the cup spring 21 first and after it the ball bearing 16 are inserted into the bearing bore 18 of the gearbox 14; then, for axial compensation of manufacturing tolerances, the ball bearing 16 is pressed with initial tension of the cup spring 21 into the bearing bore 18 so far that finally the alignment pins 22 can be press-fitted all the way into the blind bores 23 and thus penetrate the bearing bore 18 in chordlike fashion.

In FIG. 4, as a modification of the version of FIG. 2, a further cup spring 24 is fastened between the two alignment pins 22 and the ball bearing 16, so that the ball bearing 16 is braced on both sides via two cup springs 21, 24 and is axially fixed between the stop shoulder 18a of the bearing bore 18 and the alignment pins 22. This version should be employed whenever the manufacturing tolerances at the bearing point 20 cannot be completely compensated for with only a single cup spring 21, or when there is a resultant axial force for absorbing an armature deflection of the motor 11. As an alternative, it is also possible to dispose both cup springs on one face end of the ball bearing 16, in such a way that they are braced against one another. In the case of conically embodied cup springs as in FIGS. 2 and 4, care should furthermore be taken to assure that the cup springs are each braced by their outer edges on the outer ring 16b of the ball bearing 16.

The invention is not limited to the exemplary embodiments. For instance, as an alternative to FIG. 2, the cup spring 21 may also be disposed between the bearing 16 and the alignment pins. As standard parts, flat disks may optionally be used, instead of cup springs.

1-8. (canceled)

9. An electric drive unit, comprising:
an electric motor;
a gearbox attached to the motor;
a gear rotatable supported on a driveshaft disposed in the gearbox;
a bearing, preferably a ball bearing, inserted in a bearing bore of the gearbox;
a stop shoulder of the gearbox, the bearing resting on one end of the stop shoulder thereby axially fixing a first side of the bearing;
at least one locking means for axially fixing a second side of the bearing;
at least one bolt, in particular an alignment pin, embodying the locking means, the at least one bolt secured in the gearbox and protruding in chordlike fashion through the bearing bore; and
an elastic element disposed on at least one face end of the bearing.

10. The electric drive unit according to claim 9, wherein the bearing bore is penetrated in chordlike fashion by two alignment pins diametrically opposite from one another at a spacing (a).

11. The electric drive unit according to claim 10, wherein the spacing (a) of the two alignment pins from one another is greater than an outer diameter of an inner ring of the bearing, which inner ring is secured to the driveshaft of the electric motor.

12. The electric drive unit according to claim 10, wherein the spacing (a) of the two alignment pins from one another is no greater than an inside diameter of an outer ring of the bearing, which outer ring is secured in the bearing bore.

13. The electric drive unit according to claim 11, wherein the spacing (a) of the two alignment pins from one another is no greater than an inside diameter of an outer ring of the bearing, which outer ring is secured in the bearing bore.

14. The electric drive unit according to claim 9, wherein the alignment pins are inserted into bores in the gearbox which penetrate the bearing bore in chordlike fashion, wherein the bores are preferably embodied as blind bores.

15. The electric drive unit according to claim 10, wherein the alignment pins are inserted into bores in the gearbox which penetrate the bearing bore in chordlike fashion, wherein the bores are preferably embodied as blind bores.

16. The electric drive unit according to claim 11, wherein the alignment pins are inserted into bores in the gearbox which penetrate the bearing bore in chordlike fashion, wherein the bores are preferably embodied as blind bores.

17. The electric drive unit according to claim 12, wherein the alignment pins are inserted into bores in the gearbox which penetrate the bearing bore in chordlike fashion, wherein the bores are preferably embodied as blind bores.

18. The electric drive unit according to claim 13, wherein the alignment pins are inserted into bores in the gearbox which penetrate the bearing bore in chordlike fashion, wherein the bores are preferably embodied as blind bores.

19. The electric drive unit according to claim 9, wherein a cup spring embodying the elastic element is fastened between the bearing and the stop shoulder in the gearbox.

20. The electric drive unit according to claim 10, wherein a cup spring embodying the elastic element, is fastened between the bearing and the stop shoulder in the gearbox.

21. The electric drive unit according to claim 11, wherein a cup spring embodying the elastic element, is fastened between the bearing and the stop shoulder in the gearbox.

22. The electric drive unit according to claim 12, wherein a cup spring embodying the elastic element, is fastened between the bearing and the stop shoulder in the gearbox.

23. The electric drive unit according to claim 14, wherein a further cup spring is fastened between the bearing and the alignment pins.

24. The electric drive unit according to claim 15, wherein a further cup spring is fastened between the bearing and the alignment pins.

25. The electric drive unit according to claim 16, wherein a further cup spring is fastened between the bearing and the alignment pins.

26. The electric drive unit according to claim 17, wherein a further cup spring is fastened between the bearing and the alignment pins.

27. The electric drive unit according to claim 19, wherein the cup spring is embodied conically and is braced with its outer edge on the outer ring of the bearing.

28. The electric drive unit according to claim 26, wherein the cup spring is embodied conically and is braced with its outer edge on the outer ring of the bearing.
